(19) United States
(12) Patent Application Publication
(10) Pub. No.: US 2015/0073911 A1
(43) Pub. Date: Mar. 12, 2015

(54) POINT OF SALE ITEM PAYMENT OPTION SYSTEMS AND METHODS

(71) Applicant: Lucy Ma Zhao, Austin, TX (US)

(72) Inventor: Lucy Ma Zhao, Austin, TX (US)

(21) Appl. No.: 14/025,452

(22) Filed: Sep. 12, 2013

(51) Int. Cl. G06Q 30/02

(52) U.S. Cl. CPC G06Q 30/0268; G06Q 40/025
USPC 705/14.65

(57) ABSTRACT

There is provided systems and method for a point of sale item payment option. The methods include receiving user information and item information, wherein the user information and item information is received after a communication between a user device and an item point-of-sale (POS) device, determining one or more credit options or one or more incentives for purchasing an item based on the user information and the item information, and transmitting a message including the one or more credit options or the one or more incentives for display to the user. The item information may include an item identifier, an item price, an item reduced price sale offer, merchant information, and a visual image capturable by the user device. The one or more credit options may include a credit card option, an installment credit option, and a revolving credit option.

### BACKGROUND

1. Technical Field

The present application generally relates to an item payment option point of sale and more specifically to offering a potential consumer a credit option or incentive for purchasing an item when the user interacts with an item point of sale device.

2. Related Art

Consumers may visit merchants to purchase so called “big ticket” items, such as televisions, computers, furniture, or other expensive merchandise. While doing so, the consumer may browse through many similar items while looking for an item that matches both the consumer's needs and available funds. In a store location, the consumer may refrain from purchasing merchandise believed to be too expensive based on their current financial situation. Unlike an online environment, the consumer may not be offered credit options because the merchant may be unaware of the consumer's financial information and purchasing interests. Thus, the consumer may not receive potential credit offers and savings. Therefore, in such a merchant storefront, the consumer may make a purchase without being fully informed of the consumer's purchasing power or even forego a purchase completely, creating a suboptimal situation for both the consumer and the merchant.

### BRIEF DESCRIPTION OF THE DRAWINGS

FIG. 1 is a block diagram of a networked system suitable for implementing the process described herein according to an embodiment;

FIG. 2 is an exemplary item point of sale device with a user device application interface displaying a credit option for purchasing an item according to an embodiment;

FIG. 3 is a flowchart of an exemplary process by a payment provider server for providing credit options to a user after receiving user information from an item point of sale device according to an embodiment; and

FIG. 4 is a block diagram of a computer system suitable for implementing one or more components in FIG. 1 according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

In certain embodiments, a consumer may visit a merchant either to browse items for sale or look to purchase a specific item. The merchant may place various items for sale along with an item point of sale display, for example, a plaque or informational stand stating the item's price, specifications, sale offers, or other information relevant to a consumer when purchasing the item. In addition to the item point of sale display, the merchant may place an item point of sale (POS) device with the item. The item POS device may include a communication module enabling wired or wireless communication with a user device, such as a mobile phone, tablet computer, personal digital assistant (PDA), laptop computer, or other device a consumer may possess. When the consumer engages the item POS device with the user device, the item POS device may request a credit option for payment of the item to be provided to the consumer, and may display the credit option or may transmit the credit option to the user device for display to the consumer. The consumer may then select an accept option if the user is satisfied with the credit option and would like to purchase the item using the credit option.

In another embodiment, the user scans a product identifier, such as a barcode, associated with the item of interest or captures an image of the item. The item information, including price, is communicated to the merchant and/or a payment service provider. The information, along with user information, may be processed by the merchant and/or the payment service provider to determine one or more credit products and/or incentives to provide to the user. The credit and/or incentives can be a combination offered by the merchant, the payment service provider, or both, which may be communicated to the user device. The user may then purchase the item from the user device with one or more of the credit products and/or incentives. As used herein, POS device may include a passive product identifier, a tag, a label, an active device, or any other suitable identifier that can be used to convey information about the item to a user device.

In some embodiments, a consumer may set up an account with a payment service provider or other credit provider. The credit provider may include information corresponding to the consumer's credit score, available assets, or other information relevant to extending credit amounts to the consumer. Additionally, a user device may include information identifying the consumer with the account. For example, the consumer may install a payment application or other financial application on the user device possessing login information, cookies, or other identifiers corresponding to the account. In other embodiments, the user device may include other information capable of matching the consumer with the account, such as a consumer name, address, etc. Additionally, in some embodiments, a consumer may not possess an account with a credit provider and, therefore, the payment service provider/credit provider may be chosen by the merchant store or at random when a credit option is requested by the consumer.

Thus, a consumer may travel to a merchant store of the consumer's preference during a shopping trip with a user device. When the consumer browses various items for purchase, the consumer may view an item point of sale display and an item point of sale device. The consumer may “swipe” or otherwise engage the user device with the item POS device over a wired or wireless connection, for example, using near field communication, Bluetooth, Bluetooth Low Energy, radio, infrared, or other connection. Once the item POS device is connected to the user device, the item POS device may receive identifying information for the consumer. The item POS device may utilize the information to connect to a payment/credit provider and determine a credit option to provide to the consumer for purchase of the item. The payment/credit provider may determine the credit option based on consumer personal information, an account identifier, and/or a user device identifier. For example, the credit option may be based on information in a user account, such as past purchases of items using credit, available funds and future earnings, future one time payments (e.g. a tax refund), or in embodiments where the consumer has not established a user account, the payment/credit provider may receive financial information to determine a credit option for the consumer. The payment/credit provider may then transmit the credit amount back to the item POS device, which may display the credit option to the consumer, or may in turn transmit the credit option to the user device. The credit option may include an accept option, which may then initiate acceptance of the credit option with the payment/credit provider, or, conversely, a decline option.

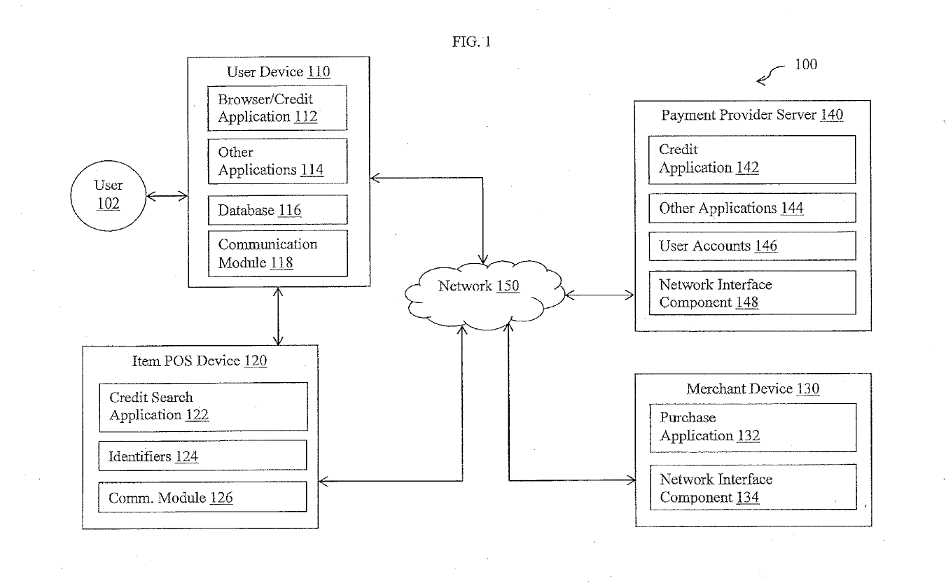

FIG. 1 is a block diagram of a networked system 100 suitable for implementing the process described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, an item point of sale (“POS”) device 120, a merchant device 130, and a payment provider server 140 in communication over a network 150. User 102, such as a consumer, may utilize user device 110 while browsing items at a merchant store or location corresponding to merchant device 130, such as a retail storefront. In certain embodiments, payment provider server 140 may receive information identifying user 102 and item POS device 120, determine a credit option for an item corresponding to item POS device 120, and transmit the credit option to one or more of user device 110, item POS device 120, and/or merchant device 130.

User device 110, item POS device 120, merchant device 130, and payment provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

User device 110 may be implemented using any appropriate hardware and software configured for wired and/or wireless communication with item POS device 120, merchant device 130, and/or payment provider server 140. For example, in one embodiment, user device 110 may be implemented as a personal computer (PC), a smart phone, personal digital assistant (PDA), laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a browser/credit application 112, other applications 114, a database 116, and a communication module 118. Browser/credit application 112 and other applications 114 may correspond to processes, procedures, and/or applications executable by a hardware processor, for example, a software program. In other embodiments, user device 110 may include additional or different software as required.

In various embodiments, browser/credit application 112 may be utilized by user 102 with user device 110 to establish, access, and maintain user account(s) and engage in online transactions using the user account(s). For example, browser application 112 may be utilized to establish one or more user accounts with a payment provider, a financial institution, or other credit provider. Browser application 112 may access the payment/credit provider to utilize and/or maintain the user accounts. The payment/credit providers may interact with other service providers, for example, by facilitating transactions using the user accounts. User 102 may utilize browser application 112 to interact with the payment/credit providers, for example, accepting credit options, negotiating credit terms, viewing credit balances, making payments, or other online interactions.

In other embodiments, browser/credit application 112 may correspond to a software application for accessing and interacting with a payment/credit provider. Thus, browser/credit application 112 may act as an interface with a payment/credit provider to establish user accounts, accept credit options, negotiate credit terms, view credit balances, make payments, or other online interactions. Additionally, browser/credit application 112 may include an option to scan for local item POS units and transmit user information, such as user personal information, a user account identifier, user financial information, and a user device identifier. Browser/credit application 112 may transmit further information, such as payment/credit provider associated with browser/credit application 112. In such embodiments, browser/credit application 112 of user device 110 may utilize short range wireless communication with the item POS device, such as near field communication, Bluetooth, Bluetooth Low Energy, radio, infrared, or other connection. Browser/credit application 112 may correspond to an application available for download over network 150, for example, from a payment/credit provider.

In various embodiments, user device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 150, or other types of applications. Other applications 114 may also include email, texting, voice and IM applications that allow a user to send and receive emails, calls, texts, and other notifications through network 150. In various embodiments, other applications 114 may include financial applications, such as banking, online payments, money transfer, or other applications associated with payment provider server 140. Other applications 114 may contain software programs, executable by a processor, including a graphical user interface (GUI) configured to provide an interface to the user.

User device 110 may further include database 116 which may include, for example, identifiers such as operating system registry entries, cookies associated with browser/credit application 112 and/or other applications 114, identifiers associated with hardware of user device 110, or other appropriate identifiers, such as identifiers used for payment/user/device authentication or identification. In one embodiment, identifiers in database 116 may be used by a payment/credit provider, such as payment provider server 140, to associate user device 110 with a particular account maintained by the payment/credit provider.

Database 116 may further contain user information or may include data to access user information. Thus, database 116 may contain further user personal information (e.g. a name, social security number, user financial information, or other identifying information), a user account identifier, and a user device identifier. In various embodiments, database 116 may include information to access user information including online account access information.

In various embodiments, user device 110 includes at least one communication module 118 adapted to communicate with item POS device 120, merchant device 130 and/or payment provider server 140. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Item POS device 120 may be may be implemented using any appropriate hardware and software configured for wired and/or wireless communication with user device 110, merchant device 130, and/or payment provider server 140. For example, in one embodiment, item POS device 120 may be implemented as a display device including a hardware processor for executing applications stored in a memory and a communication module. Item POS device 120 may also be implemented as a personal computer (PC), a smart phone, personal digital assistant (PDA), laptop computer, and/or other types of computing devices capable of transmitting and/or receiving data, such as an IPAD® from APPLE®. Although an item POS device is shown, the item POS device may be managed or controlled by any suitable processing device. Although only one item POS device is shown, a plurality of item POS devices may be utilized.

Item POS device 120 of FIG. 1 contains a credit search application 122, identifiers 124, and a communication module 126. Credit search application 122 may correspond to processes, procedures, and/or applications executable by a hardware processor, for example, a software program. In other embodiments, item POS device 120 may include additional or different software as required.

In various embodiments, credit search application 122 may be utilized to communicate with user device 110, merchant device 130, and/or payment provider server 140. Credit search application 122 may receive user information from user device 110 using wired or wireless communication. Credit search application 122 may receive the user information by requesting user information when a communication link is established between user device 110 and item POS device 120. In other embodiments, user device 110 may transmit user information to item POS device 120, for example, when user device 110 connects to item POS device 120 and runs an application, such as browser/credit application 112. Additionally, credit search application 122 may retrieve identifiers corresponding to item POS device 120, such as identifiers 124, which may include identifiers associated with hardware of item POS device 120 or other appropriate identifiers user for identifying item POS device 120 and/or an associated item.

Using user information and identifiers corresponding to item POS device 120, credit search application 122 may initiate a credit search process with a payment/credit provider, such as payment provider server 140, for an item corresponding to item POS device 120. The credit search process may include determining a payment/credit provider associated with the user information, determining credit availability using the user information, and/or determining a credit option for a user corresponding to the user information, for example, user 102. In other embodiments, the credit search process may search one or a plurality of available payment/credit providers and determine one or more credit options available to user 102.

Once credit search application 122 determines at least one credit option for user 102 to utilize to pay for an item corresponding to item POS device 120, credit search application 122 may provide the credit option(s) to user 102. Credit search application may transmit the credit option to user device 110 for display to user 102. However, in other embodiments, item POS device 120 may include a display and input device, and user 102 may view and accept/decline the credit option using item POS device 120. Additionally, in certain embodiments, credit search application 122 may transmit the credit option to a merchant device, such as merchant device 130, for acceptance by user 102, or may transmit user 102's response to the merchant device.

Item POS device 120 may further include identifiers 124, for example, identifiers such as operating system registry entries, cookies associated with credit search application 122, identifiers associated with hardware of item POS device 120, or other appropriate identifiers. In one embodiment, identifiers 124 may be used by a payment/credit provider, such as payment provider server 140, to associate item POS device 120 with a particular product.

In various embodiments, item POS device 120 includes at least one communication module 126 adapted to communicate with user device 110, merchant device 130 and/or payment provider server 140 over network 150. In various embodiments, communication module 126 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Merchant device 130 may be maintained, for example, by a merchant or seller offering various items, products, and/or services through a merchant location. Generally, merchant device 130 may be maintained by anyone or any entity that receives money, which includes charities as well as retailers and restaurants. In this regard, merchant device 130 may include processing applications, which may be configured to interact with user device 110 and/or payment provider server 140 to facilitate the sale of products, goods, and/or services.

Merchant device 130 may be implemented using any appropriate hardware and software configured for wired and/or wireless communication with user device 110, item POS device 120, and/or payment provider server 140. For example, in one embodiment, merchant device 130 may be implemented as a single or networked personal computer (PC), a smart phone, personal digital assistant (PDA), laptop computer, and/or other types of computing devices at a merchant location capable of transmitting and/or receiving data. Although a merchant device is shown, the merchant device may be managed or controlled by any suitable processing device. Although only one merchant device is shown, a plurality of merchant devices may be utilized.

Merchant server 130 includes a purchase application 132 and a network interface component 134. Purchase application 132 may correspond to processes, procedures, and/or applications executable by a hardware processor, for example, a software program. In other embodiments, merchant device 130 may include additional or different software as required

Purchase application 132 may be configured to provide a convenient interface to permit a salesperson to select, review, and sell items to user 102. For example, purchase application 132 may be implemented as an application having a user interface enabling the user to buy products available at a merchant corresponding to merchant device 130. Thus, purchase application 132 may include an interface displaying user selected products for purchase, including product information, purchase price, and total purchase costs. In some embodiments, purchase application 132 may correspond more generally to a web browser configured to view merchant information available over the Internet or access a website corresponding to products available from a merchant. Thus, purchase application 132 may also be utilized to access merchant websites and engage in online transactions, for example purchasing of inventory available in at other merchant locations, warehouses, or different merchants.

Purchase application 132 may further include information corresponding to a payment method selected by user 102. For example, purchase application 132 may include cash, check, credit card, credit option, or other payment method. Thus, if user 102 selects to pay using the credit option for an item corresponding to item POS device 120, purchase application 132 may display the credit amount and engage in the proper steps of accepting, authorizing, and/or receiving the credit option, including a monetary amount of the credit option, and completing purchase of the products using the credit option. Purchase application 132 may communicate with a payment/credit provider, such as payment provider server 140 over network 150 to authorize the credit amount extended to user 102, and receive payment from the payment/credit provider. In other embodiments, purchase application 132 may communicate with user device 110 and/or item POS device 120 to receive information corresponding to the credit option.

In various embodiments, merchant device 130 includes at least one network interface component 134 adapted to communicate with user device 110, item POS device 120, and/or payment provider server 140 over network 150. In various embodiments, communication module 134 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. In other embodiments, network interface component 134 may communicate directly with user device 110 and item POS device 120 without network 150.

Payment provider server 140 may be maintained, for example, by an online payment service provider, which may provide credit services and/or processing for financial transactions on behalf of a user with a merchant. In this regard, payment provider server 140 includes one or more processing applications which may be configured to interact with user device 110, item POS device 120, and/or merchant device 130 to facilitate an offer and acceptance of credit options and/or payments. In one example, payment provider server 140 may be provided by PayPal®, Inc. of San Jose, Calif., USA. However, in other embodiments, payment provider server 140 may be maintained by or include a credit provider, financial services provider, financial data provider, and/or other service provider, which may provide credit options based on user, item, and/or merchant information. Payment provider server 140 may additionally perform credit option authorization and payment of goods with credit, for example, the exchange of goods between a merchant and user 102 based on credit extended to user 102.

Payment provider server 140 of FIG. 1 includes a credit application 142, other applications 144, user accounts 146, and a network interface component 148. Credit application 142 and other applications 144 may correspond to processes, procedures, and/or applications executable by a hardware processor, for example, a software program. In other embodiments, payment provider server 140 may include additional or different software as required.

Credit application 142 of payment provider server 140 may be configured to communicate information with user device 110, item POS device 120, and/or merchant device 130 over network 150. In various embodiments, credit application 142 receives user information corresponding to user 102 and item information corresponding to item POS device 120 (e.g. an item identifier, price, item reduced price sale information, and/or other item information), determines a credit option to extend to user 102 for the item, and communicates the credit option to user 102. Credit application 142 may additionally receive merchant information identifying the merchant. Credit application 142 may receive the user information and/or item information from user device 110, item POS device 120, or both. Credit application 142 may transmit additional information with the credit option, such as credit card offers, credit terms, revolving credit options (e.g. a bill me later option), or other information.

Credit application 142 may determine a credit option based on user information, such as user personal information, a user account identifier, and a user device identifier, and item information. For example, credit application 142 may include user credit rating review processes, processes to determine user assets and debts, user purchase and payment history, or other processes necessary to determine an amount of credit to extend to user 102. In various embodiments, credit application 142 may access a user account stored on or external to payment provider 140 to determine the credit amount, including a payment account with payment provider server 140, bank accounts, credit card accounts, or other user accounts. Credit application 142 may receive an account identifier from user device 110, or otherwise identify the account through an identifier corresponding to user 102/user device 110.

Credit application 142 may further receive item information from item POS device 120. Item information may include item identification or an item identifier enabling item identification (e.g. a bar code or serial number), item price, and additional item information include sale offers and/or warranties. Item information may be utilized by credit application 142 with user information to determine a credit option. Credit application 142 may receive the user information and item information from item POS device 120, for example after user device 110 connects to item POS device 120. However, in other embodiments, user device 110 and/or merchant device 130 may provide one or both of the user information and item information to credit application 142.

Credit for the particular item and user may be determined using additional information, such as merchant offers and incentives, user financial information, time/day of year, etc. For example, a user may scan or otherwise capture item information for a diamond necklace at Store A. The payment provider may determine that Store A offers special incentives for loyal shoppers, Store A needs to sell the necklace soon since more will be arriving, the user will be having additional funds soon (due to an upcoming monthly work payment deposit), debts were just paid (such as a mortgage payment), high credit score, numerous successful transactions with the payment provider, the user is a loyal customer of Store A, the user typically makes minimum payments but on time, and the user's wife's birthday is coming up. In this case, the user may be presented with a credit option of low monthly payments with the first payment not due until shortly after work funds are expected to appear, a store incentive of 10% off (for loyal customers), and $500 off (to incentivize a quick sale). Thus, an incentive may also be determined and transmitted with or in place of a credit option.

In various embodiments, payment provider server 140 includes other applications 144 as may be desired in particular embodiments to provide features to payment provider server 140. For example, other applications 144 may include security applications for implementing server-side security features, programmatic server applications for interfacing with appropriate application programming interfaces (APIs) over network 150, or other types of applications. Other applications 144 may contain software programs, executable by a processor, including a graphical user interface (GUI), configured to provide an interface to a user.

Additionally, payment provider server 140 may include user accounts 146. As previously discussed, user 102 may establish one or more user accounts with payment provider server 140. User accounts 146 may include user information, such as name, address, birthdate, payment/funding information, additional user financial information, and/or other desired user data. User 102 may link user accounts 144 to user device 110 through a user device identifier. Thus, when a device identifier corresponding to user device 110 is transmitted to payment provider server 140, e.g. from user device 110, item POS device 120, and/or merchant device 130, a user account belonging to user 102 may be found. However, in other embodiments, user 102 may not have previously established a user account. Thus, payment provider server 140 may determine a credit option using different user information, such a name, social security number, user financial information, or other user information.

In various embodiments, payment provider server 140 includes at least one network interface component (NIC) 148 adapted to communicate with network 150 including user device 110, item POS device 120, and/or merchant device 130. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

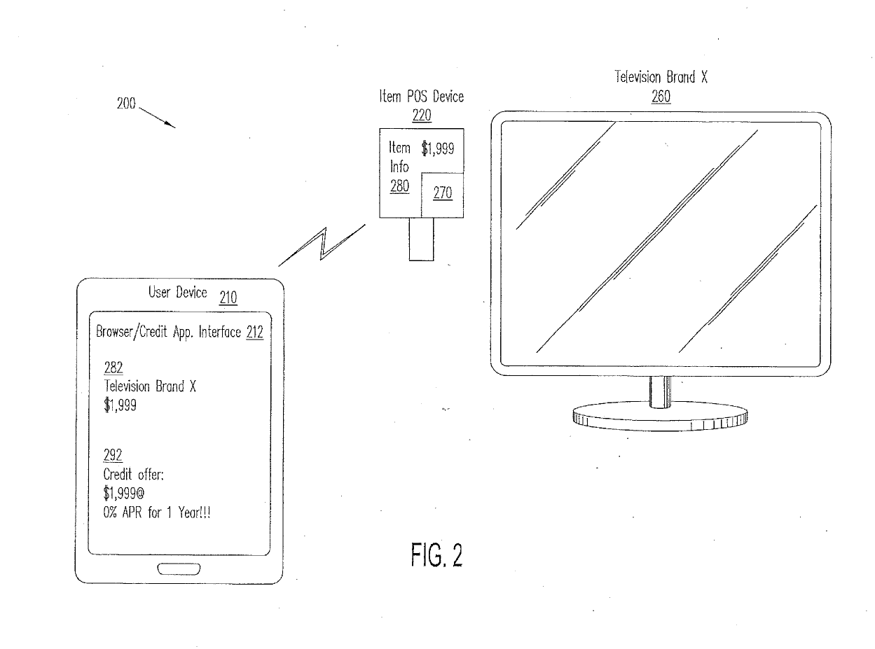

FIG. 2 is an exemplary item point of sale device with a user device application interface displaying a credit option for purchasing an item according to an embodiment. Merchant environment 200 shows a user device application interface corresponding generally a software interface of a browser/credit application, executable by one or more hardware processors, and an item POS device and corresponding item. The item POS device may provide a credit option to a user for the item. Thus, user device 210, browser/credit application interface 212, and item PUS device 220 may correspond generally to user device 110, browser/credit application 212, and item POS device 120, respectively, of FIG. 1.

Item 260 corresponding to television brand X may be an item for purchase at a merchant location 200, such as a retail storefront. Item 260 may correspond to merchandise for purchase and pick-up at the merchant location. However, in other embodiments, item 260 may correspond just to an item display or item information and item 260 may be deliverable or picked-up at a later date. In some embodiments, item 260 may correspond to services instead of goods.

Item 260 may be on display for purchase with an item POS device 220, include item information 280, such as item description, price, sale amount, warranty, or other information associated with the sale of item 260. Additionally, item POS device 220 include communication interface 270, which may correspond generally to a physical embodiment of communication module 126 of FIG. 1. For example, communication interface 270 may correspond to a small pad or area that states, “Swipe phone here for credit options!” In such an embodiment, communication interface 270 may include a near field communication unit configured to connect and interact with user device 210, such as by retrieving user information from user device 210 and utilizing the user information with item information to determine a credit option for a user corresponding to user device 210. In other embodiments, communication interface 270 may correspond to a different wired and/or wireless communication module, including microwave, radio frequency, infrared, Bluetooth, and Bluetooth low energy.

Item POS device 220 contains item information 280, such as item identification, item price, item sale information (e.g. item reduce price sale offer/information), and item data (e.g. size, weight, contents, etc.). Item information 280 may include information sent to item device 210 and/or a payment/credit provider. Additionally, item information 280 may be displayed for a user to view when browsing or searching items available for purchase. Item information may further correspond to an item identifier (e.g. a bar code, serial number, or other identifying information), merchant information (e.g. merchant name, merchant location, merchant sale information, merchant stock information, or other information corresponding to a merchant), and a visual image capturable by the user device (e.g. a picture of the item, a scannable bar code, or other image/photograph that a user may capture using a user device.)

Item POS device 220 is in communication with user device 210 through wired and/or wireless communication, including wireless network, a headphone or other input/output jack, microwave, radio frequency, infrared, Bluetooth, Bluetooth low energy, and/or near field communication. User device 210 includes a browser/credit application interface 212 displaying item information 282 and credit option 292. As previously discussed, browser/credit application interface 212 may correspond generally to browser/credit application 112 of FIG. 1. Thus, browser/credit application interface 212 may correspond to a software interface, where the software is configured to communicate with item POS device 220 to facilitate providing credit options for item 260 to a user.

Item information 282 may correspond generally to all or some subset of item information 280 visible in browser/credit application interface 212. Item information 282 may additionally include further information, such as stock/availability, sale prices available online, at other merchant locations, or with other merchants. As shown in FIG. 2, item information 282 includes a name of item 260, “television brand X,” and a price, “$1,999.”

Browser/credit application interface 212 further displays credit option 292. Credit option 292 may correspond generally to an amount of credit extended to a user to purchase item 260, including credit terms. Credit option 292 may include a credit preauthorization amount, a credit card offer, a revolving credit amount, an installment credit amount, or other credit option. Credit option may be extended to the user when user device 210 connects with item POS device 220. Item POS device 220 may receive user information from user device 210, for example, user personal information, a user account identifier, user financial information, and a user device identifier. Item POS device 220 may then connect to a network and send a request for a credit option to a payment/credit provider, such as payment provider server 140 of FIG. 1. Item POS device 220 may transmit the user information with item information, and in some embodiments, merchant information. The payment/credit provider may determine an amount and terms of at least one credit option using the user information, item information, and/or merchant information.

In other embodiments, credit options 292 may correspond to an incentive and/or include one or more incentives for display to the user with a credit option. An incentive may correspond to merchant offers and/or incentives to entice a user to purchase an item. The incentives may include rebates or money back offers, loyal customer sales, good credit and/or payment history incentives, or other offers to obtain a purchase by a user.

Once the payment/credit provider has determined at least one credit option to extend to a user for item 260, the payment/credit provider may transmit the credit option(s) to item POS device 220. Item POS device 220 may then transmit the credit option(s) to user device 210 for display to the user. The credit option may also include a means for acceptance of the credit option, such as a button to initiate an executable process, a hyperlink to the payment/credit provider, a text message with the credit option and instructions to accept the credit option, or other process. In some embodiments, where browser/credit application interface includes an application with a graphical user interface (GUI), the application may include a process to accept the credit option.

Alternatively, where item POS device 220 does not include a network connection, item POS device 220 may connect to a merchant device and transmit user information and item information for the merchant device to request a credit option. In other embodiments, user device 210 may receive item information from item POS device 220 and utilize a network connection to connect to a payment/credit provider to request a credit option.

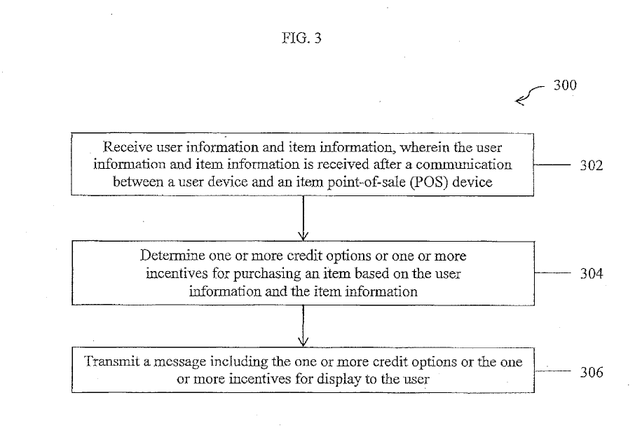

FIG. 3 is a flowchart of an exemplary process by a payment provider server for providing credit options to a user after receiving user information from an item point of sale device according to an embodiment. Note that one or more steps, processes, and methods described herein may be omitted, performed in a different sequence, or combined as desired or appropriate.

At step 302, a payment/credit provider server, such as payment provider server, receives user information and item information after a communication between a user device and an item POS device. Item POS device 120/220 may transmit the user information and the item information when user 102 connects user device 110/210 to item POS device 120/220 using wired or wireless communication, such as a wired connection, wireless network connection, near field communication, radio communication, infrared communication, Bluetooth communication, and Bluetooth low energy communication. In other embodiments, the user device may transmit the user information and/or item information, or a merchant device/server corresponding to the item POS device may transmit the user information and/or item information to the payment provider.

User information may correspond to user personal information, a user account identifier, user financial information, and a user device identifier. User information may enable a payment/credit provider to determine a credit option to extend to user 102. For example, user information may include asset/debt information, income stream information, credit information, tax information, or other user financial information. Item information may correspond to an item identifier, an item price, and an item reduced price sale offer. Item information may determine the amount and/or availability of a credit option to extend to user 102.

Once user information and item information is received, one or more credit options or one or more incentives is determined for an item corresponding to the item POS device using the user information and the item information, at step 304. The one or more credit options may include at least one of a credit card option, an installment credit option, and a revolving credit option. Thus, the credit options may include multiple credit options with different terms and/or different services, giving user 102 options to select a credit option that fits user 102. Additionally, one or more incentives may be determined, where the one or more incentives correspond to a loyal customer discount, a good credit discount, a discount based on inventory levels, a seasonal discount, and a merchant specific discount.

At step 306, a message including the one or more credit options or the one or more incentives is transmitted for display to the user. The message may also include a means to accept the credit option, including instructions, a button with an executable process, a hyperlink or embedded link/process, or other process. Additionally, the message may be transmitted to item POS device 120/220 for display to user 102, or item POS device 120/220 may transmit the message including the credit option to user device 110/210 for display to user 102. In other embodiments, the message including the credit option may be transmitted directly to user device 110/210, or may be transmitted to merchant device 130 for acceptance by user 102 at merchant device 130, including payment for item 260 with merchant device 130.

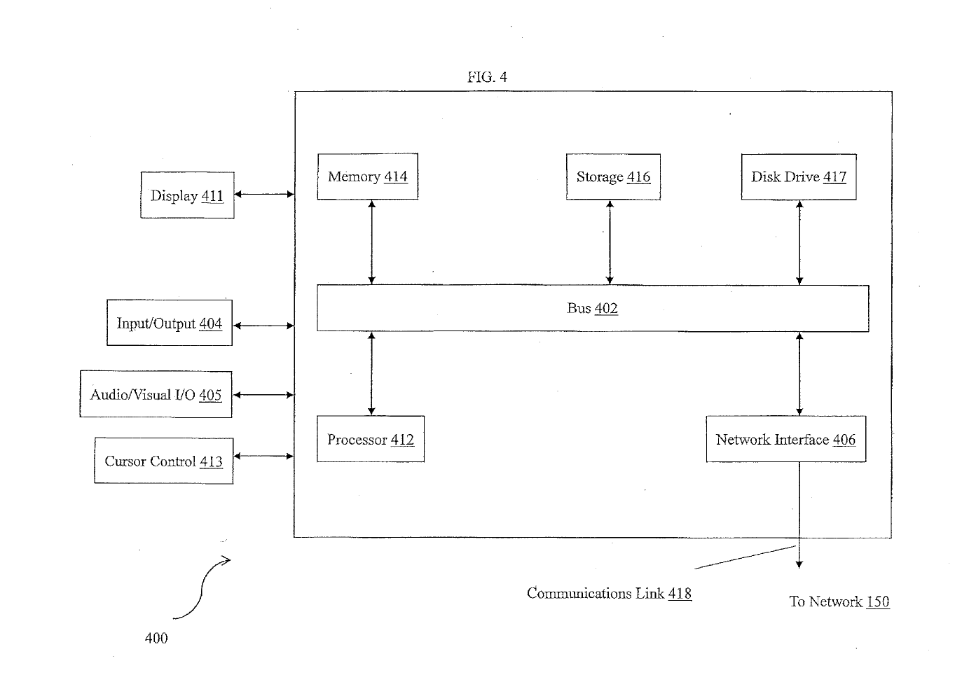

FIG. 4 is a block diagram of a computer system 400 suitable for implementing one or more embodiments of the present disclosure. In various embodiments, the user device may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons, image, or links, and/or moving one or more images, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a service provider server via network 150. In one embodiment, the transmission is wireless, although other transmission mediums and methods may also be suitable. One or more processors 412, which can be a micro-controller, digital signal processor (DSP), or other processing component, processes these various signals, such as for display on computer system 400 or transmission to other devices via a communication link 418. Processor(s) 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor(s) 412 and other components by executing one or more sequences of instructions contained in system memory component 414. Logic may be encoded in a computer readable medium, which may refer to any medium that participates in providing instructions to processor(s) 412 for execution. Such a medium may take many forms, including but not limited to, non-volatile media, volatile media, and transmission media. In various embodiments, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing user account information, wherein the user account information comprises user financial information; and
one or more hardware processors in communication with the non-transitory memory and configured to:
receive user information and item information, wherein the user information and item information is received after a communication between a user device and an item point-of-sale (POS) device;
determine one or more credit options or one or more incentives for purchasing an item based on the user information and the item information; and
transmit a message including the one or more credit options or the one or more incentives for display to the user.

2. The system of claim 1, wherein the user information is one of user personal information, a user account identifier, the user financial information, and a user device identifier.

3. The system of claim 1, wherein the user device connects to the item POS device using one of near field communication, radio communication, infrared communication, Bluetooth communication, and Bluetooth low energy communication.

4. The system of claim 1, wherein the item information includes at least one of an item identifier, an item price, an item reduced price sale offer, merchant information, and a visual image capturable by the user device.

5. The system of claim 1, wherein the one or more credit options is one of a credit card option, an installment credit option, and a revolving credit option.

6. The system of claim 1, wherein the one or more incentives is one of a loyal customer discount, a good credit discount, a discount based on inventory levels, a seasonal discount, and a merchant specific discount.

7. The system of claim 1, wherein the message is transmitted to the item POS device for display to the user.

8. The system of claim 1, wherein the message is transmitted to the item POS device for transmission to the user device for display to the user.

9. A method comprising:
receiving user information and item information, wherein the user information and item information is received after a communication between a user device and an item point-of-sale (POS) device;
determining, using a hardware processor of a payment provider server, one or more credit options or one or more incentives for purchasing an item based on the user information and the item information; and
transmitting a message including the one or more credit options or the one or more incentives for display to the user.

10. The method of claim 9, wherein the user device connects to the item POS device using one of near field communication, radio communication, infrared communication, Bluetooth communication, and Bluetooth low energy communication.

11. The method of claim 9, wherein the item information includes at least one of an item identifier, an item price, an item reduced price sale offer, merchant information, and a visual image capturable by the user device.

12. The method of claim 9, wherein the credit options is one of a credit card option, an installment credit option, and a revolving credit option.

13. The method of claim 9, wherein the message is transmitted to the item POS device for display to the user.

14. The method of claim 9, wherein the message is transmitted to the item POS device for transmission to the user device for display to the user.

15. A non-transitory computer readable medium comprising a plurality of machine-readable instructions which when executed by one or more processors of a server are adapted to cause the server to perform a method comprising:
receiving user information and item information, wherein the user information and item information is received after a communication between a user device and an item point-of-sale (POS) device;
determining one or more credit options or one or more incentives for purchasing an item based on the user information and the item information; and
transmitting a message including the one or more credit options or the one or more incentives for display to the user.

16. The non-transitory computer readable medium of claim 15, wherein the user device connects to the item POS device using one of near field communication, radio communication, infrared communication, Bluetooth communication, and Bluetooth low energy communication.

17. The non-transitory computer readable medium of claim 15, wherein the item information includes at least one of an item identifier, an item price, an item reduced price sale offer, merchant information, and a visual image capturable by the user device.

18. The non-transitory computer readable medium of claim 15, wherein the credit options is one of a credit card option, an installment credit option, and a revolving credit option.

19. The non-transitory computer readable medium of claim 15, wherein the message is transmitted to the item POS device for display to the user.

20. The non-transitory computer readable medium of claim 15, wherein the message is transmitted to the item POS device for transmission to the user device for display to the user.
